(19) United States
(12) Patent Application Publication
(10) Pub. No.: US 2007/0088112 A1
(43) Pub. Date: Apr. 19, 2007

(54) FIRE RETARDANT COMPOSITIONS

(76) Inventor: HENRY EARL HOOKS, Tupelo, MS (US)

Correspondence Address: WOOD AND EISENBERG, PLLC, 6911 RICHMOND HIGHWAY, SUITE 403, Alexandria, VA, 22306, US

(21) Appl. No.: 11/539,135

(22) Filed: Oct. 5, 2006

Related U.S. Application Data
(60) Provisional application No. 60/723,394, filed on Oct. 5, 2005.

(51) Int. Cl. C08K 3/38; C08K 3/32; C08K 3/30; C08K 3/26

(52) U.S. Cl. 524/404; 524/414; 524/423; 524/425

(57) ABSTRACT

A fire retardant composition able to withstand 5,000° F., comprising: an acrylic copolymer, tricalcium phosphate, a hardener, ammonium chloride, calcium carbonate, aluminum potassium sulfate, alumina trihydrate, perlite, vermiculite, and corn starch.

### STATEMENT REGARDING FEDERALLY SPONSORED RESEARCH OR DEVELOPMENT

This application claims the benefit of priority from U.S. Provisional Patent Application Ser. No. 60/723,394, filed Oct. 5, 2005, the entire contents of which are incorporated herein by reference.

### CROSS-REFERENCE TO RELATED APPLICATIONS

Not Applicable.

### FIELD OF THE INVENTION

This invention is a fire retardant composition that enables items, otherwise susceptible to heat and fire, to withstand temperatures of about 5,000 degrees Fahrenheit.

### BACKGROUND OF THE INVENTION

U.S. Pat. No. 4,849,135, issued to Reitz, describes ethylene copolymers with enhanced fire resistant properties, which with the addition of certain phosphate esters causes ethylene copolymers containing CaCO₃ and/or Ca—Mg/CO₃ and alumina trihydrate to have lower swell on burning and to have smaller and more uniform cell formation in the ceramic ash than compositions without such esters present.

U.S. Pat. No. 4,702,861, issued to Farnum, describes a flame retardant formulation for application as an aqueous working dispersion onto surfaces of normally combustible materials. Upon exposure to elevated temperatures and/or flame, the formulation creates a substantially continuous protective film as it undergoes a transition of composition, with the protective film generally encapsulating and/or enveloping the surface of the article onto which it is applied. In addition to being insulative, the film excludes oxygen from the surface of the substrate, and is capable of radiating infrared and visible light when exposed to elevated temperatures. In the formulation, and upon exposure to elevated temperatures and/or flame, the material releases forms of chlorine, bromine, and phosphorus, for the protection that these materials provide. In addition, antimony oxide is present for its protective property, together with hydrated alumina for its water-release capability.

U.S. Pat. No. 5,158,999, issued to Swales et al., describes flame retarded polymers that are particularly suitable for use in wire and cable insulation, dimensionally recoverable products, molded parts, extruded tubings, pipes and tape type constructions.

None of the above patents, taken either singly or in combination, is seen to describe the instant invention as claimed.

### SUMMARY OF THE INVENTION

A fire retardant composition able to withstand 5,000° F., comprising: an acrylic copolymer, tricalcium phosphate, a hardener, ammonium chloride, calcium carbonate, aluminum potassium sulfate, alumina trihydrate, perlite, vermiculite, and corn starch.

### DETAILED DESCRIPTION OF THE PRESENT INVENTION

The invention is directed to fire retardant compositions that enable items, otherwise susceptible to heat and fire, to withstand temperatures of about 5,000 degrees Fahrenheit and can withstand the heat of a burner using MAPP Gas (with C₃H₄) that is reported to produce heat in excess of 5,000° F.

The fire retardant compositions of the present invention include a copolymer and a resin. Any kind of suitable polymer can be used such as, but not limited to, an acrylic copolymer. Examples of suitable polymers include VF-812, which is a liquid polymer sold with, for example, the Forton MG Casting System supplied by Ball Consulting Limited of Ambridge, Pa. (Main Office: Ball Consulting Ltd., Suite 201, 338 14^{th} Street, Ambridge, Pa. 15003, TEL: 1-800-225-2673). Other suppliers of VF-812 include Douglas and Sturgess, Inc. (stock code: SC-12441) of 730 Bryant Street, San Francisco, Calif. 94107 (TEL: 1-888-ART-STUF, FAX: 1-510-235-4211). Suitable resins for use with the VF-812 polymer include melamine resin (available from Douglas and Sturgess, Inc., stock code: SC-12442). Other resins that can be used include benzoguanamine resins, glycoluril resins or urea resins (as described for example in U.S. Pat. No. 6,855,792, which is incorporated herein by reference in its entirety). In one embodiment, the resin is at least one resin selected from the group consisting of: melamine resin, benzoguanamine resin, glycoluril resin and urea resin.

Ammonium chloride can be used to facilitate cross-linking of the VF-812 and the melamine resin. It is believed that ammonium chloride acts as a pH adjuster facilitating the formation of cross-links between polymer VF-812 and the melamine resin. The amount of ammonium chloride added can vary according to the item of application or item to be treated.

It should be understood that any suitable acrylic copolymer can be used such as, but not limited to, styrene-acrylic copolymer.

It is believed that the present invention provides the first known use of acrylic copolymers in making fire retardant compositions able to withstand temperatures of at least 5,000 degrees Fahrenheit.

The fire retardant composition of the present invention can be applied in 1 cm thickness with, for example, a spatula or a brush depending on the viscosity of the composition being applied, which varies according to the degree of progress in the cross-linking reaction. The greater the cross-linking the more viscous and hard the composition. The Applicant has observed that it is possible to control the process of hardening (i.e., curing) by varying the amount of ammonium chloride added to the mixture. For example, a worker can use a brush during the early stages of curing to apply a coating of the fire retardant composition, but once the fire retardant composition has cured to the point it is more viscous, the composition of the invention can be applied using, for example, a spatula.

Table 1 shows one non-limiting embodiment of the fire retardant composition of the present invention. The dry ingredients #2 through #12 are mixed together in the relative amounts shown to form a mixture. Liquid polymer (listed as ingredient #1) is added to the mixture and mixed in to provide an acrylic copolymer based fire retardant composition according to the invention. The acrylic copolymer based fire retardant composition is allowed to cure. The acrylic copolymer based fire retardant composition is applied to the surface of a normally combustible material, and can be applied to such surfaces during the curing process. An item covered in the fire retardant composition of the present invention is able to withstand about 15 to 20 seconds of MAPP Gas tip heat in excess of 5,000° F. MAPP gas contains methylacetylene-propadiene (C₃H₄). MAPP is the trade name for a product of the Dow Chemical Company.

Alternatively, ingredients #2 through #5 and ingredients #7 through #12 are mixed together in the relative amounts shown in Table 1 to provide a second mixture. Polymer (ingredient #1) is mixed into the second mixture, and ammonium chloride (listed as ingredient #6) is added in a sufficient amount to bring the second mixture (with polymer) into a suitable pH range for allowing cross-linking between the polymer (listed as ingredient #1) and resin (listed as ingredient #4, such as melamine resin).

A worker quickly learns how much ammonium chloride to control the curing (cross-linking) stage to suit a particular fire-proofing project. For example, if a worker plans to use a paintbrush or similar implement to apply a coating of the fire retardant composition of the present invention, then the worker might add less ammonium chloride; whereas if the worker desired to apply a thicker coating (e.g., of about 1 cm thickness) then the worker might add more ammonium chloride to maintain a longer period for cross-linking to occur.

Table 2 shows one non-limiting embodiment of the fire retardant composition of the present invention.

Table 3 shows another non-limiting embodiment of the fire retardant composition of the present invention in which amounts of ingredients are expressed in parts per 100 parts of acrylic copolymer (ingredient #1) by weight. For example, about 60 to about 100 parts by weight of magnesium sulfate per 100 parts of acrylic copolymer by weight. The amount of corn starch (#12) can be varied outside the stated 20 to about 40 parts by weight per 100 parts of acrylic copolymer. For example, the amount of corn starch can be 1 to about 20 parts by weight per 100 parts of acrylic copolymer. Thus, the amount of corn starch can be 1 to about 40 parts by weight per 100 parts of acrylic copolymer. The corn starch can be obtained from any suitable supplier and is expressly not limited to Argo corn starch obtained from Walmart. It should be understood that any theory or proposed mechanism is not intended to limit the invention in any way such that if any theory or proposed mechanism proves to be wrong, this does not impact on the present invention which stands on its own feet as defined in the claims section.

It is to be understood that the present invention is not limited to the embodiments described above, but encompasses any and all embodiments within the spirit of the invention.

TABLE 1

| | Composition | | Stock Code (SC) and/or | | |
|---|---|---|---|---|---|
| # | Ingredients | Amount | CAS # and/or Bar Code | Supplier | FORM |
| 1 | Polymer | 8 oz to 12 oz, where 8 oz | SC: VF-812 | Ball Consulting¹ | Liquid |
| | | corresponds to about 48 teaspoons | | | |
| | | (i.e., about 6 teaspoons to 1 oz). | | | |
| | | Therefore about 48 to about 72 | | | |
| | | teaspoons of polymer VF-812. | | | |
| 2 | Magnesium Sulfate | 10 teaspoons | SC: SLM2227-500G | Sciencelab.com³ | Dry |
| | | | CAS#: 7487-88-9 | | |
| 3 | Tricalcium phosphate | 8 teaspoons | CAS#: 1306-06-5 | Monsanto⁶ | Dry |
| 4 | Melamine resin⁹ | 2 teaspoons | SC: MF-415.1 | Ball Consulting¹ | Dry |
| 5 | Borax | 8 teaspoons | SC: SLB3373-500ML | Sciencelab.com³ | Dry |
| 6 | Ammonium chloride | 2 teaspoons | — | Ball Consulting¹ | Dry |
| 7 | Calcium carbonate | 4 teaspoons | SC: FGR95 | Ball Consulting¹ | Dry |
| 8 | Aluminum Potassium | 2 teaspoons | SC: SLA3973-500G | Sciencelab.com³ | Dry |
| | Sulfate | | | | |
| 9 | Alumina Trihydrate | 4 teaspoons | SC: KC-100 | Carolina⁷ | Dry |
| 10 | Perlite | 8 teaspoons | Bar code: 7284570104 | Schultz | Dry |
| | | | | Company⁴ | |
| 11 | Vermiculite | 8 teaspoons | SC: S-3327 | ULINE² | Dry |
| 12 | Corn Starch⁸ | 4 teaspoons | Bar code: 4800107104 | Walmart⁵ | Dry |

¹Contact details for Ball Consulting: 338 14^{th} Street, Suite 201, Ambridge, PA 15003; TEL: 724-266-1502.
²Contact details for ULINE: 2105 S. Lakeside Dr., Waukegan, IL 60085; TEL: 800-958-5463.
³Contact details for Sciencelab.com: Sciencelab.com Inc., 14025 Smith Rd., Houston, Texas 77396; TEL: 800.901.7247, FAX: 281-441-4409.
⁴Schultz Company, PO Box 173, St. Louis, MO 63043-9173.
⁵Walmart, 2270 W. Main St., Tupelo, MS 38801 (Walmart store at which Argo Corrn Starch was purchased).
⁶Monsanto Company, 800 North Lindberg Boulevard, St. Louis, Missouri, 63167.
⁷Carolina Calcium Products Division, Highway 176 East, Campobello, South Carolina, 29322; TEL: 803-468-4588
⁸Any suitable starch such as, but not limited to, Argo Corn Starch.
⁹Any suitable resin will suffice such as, but not limited to, melamine resin, benzoguanamine resin, glycoluril resin or urea resins.

TABLE 2

| | Composition | Approximate Amounts | Stock Code (SC) and/or | | |
|---|---|---|---|---|---|
| # | Ingredients | in Ounces weight | CAS # and/or Bar Code | Supplier | FORM |
| 1 | Polymer VF-812 | 8 oz to 12 oz | SC: VF-812 | Ball Consulting¹ | Liquid |
| 2 | Magnesium Sulfate | 6 oz to 10 oz | SC: SLM2227-500G | Sciencelab.com³ | Dry |
| | | | CAS#: 7487-88-9 | | |
| 3 | Tricalcium phosphate | 6 oz to 8 oz | CAS#: 1306-06-5 | Monsanto⁶ | Dry |
| 4 | Melamine resin⁹ | 1 oz to 2 oz | SC: MF-415.1 | Ball Consulting¹ | Dry |
| 5 | Borax | 4 oz to 8 oz | SC: SLB3373-500ML | Sciencelab.com³ | Dry |
| 6 | Ammonium chloride | 1 oz to 2 oz | — | Ball Consulting¹ | Dry |
| 7 | Calcium carbonate | 2 oz to 4 oz | SC: FGR95 | Ball Consulting¹ | Dry |
| 8 | Aluminum Potassium | 1 oz to 2 oz | SC: SLA3973-500G | Sciencelab.com³ | Dry |
| | Sulfate | | | | |
| 9 | Alumina Trihydrate | 2 oz to 4 oz | SC: KC-100 | Carolina⁷ | Dry |
| 10 | Perlite | 4 oz to 8 oz | Bar code: 7284570104 | Schultz | Dry |
| | | | | Company⁴ | |
| 11 | Vermiculite | 2 oz to 8 oz | SC: S-3327 | ULINE² | Dry |
| 12 | Corn Starch⁸ | 2 oz to 4 oz | Bar code: 4800107104 | Walmart⁵ | Dry |

¹Contact details for Ball Consulting: 338 14^{th} Street, Suite 201, Ambridge, PA 15003; TEL: 724-266-1502.
²Contact details for ULINE: 2105 S. Lakeside Dr., Waukegan, IL 60085; TEL: 800-958-5463.
³Contact details for Sciencelab.com: Sciencelab.com Inc., 14025 Smith Rd., Houston, Texas 77396; TEL: 800.901.7247, FAX: 281-441-4409.
⁴Schultz Company, PO Box 173, St. Louis, MO 63043-9173.
⁵Walmart, 2270 W. Main St., Tupelo, MS 38801 (Walmart store at which Argo Corn Starch was purchased).
⁶Monsanto Company, 800 North Lindberg Boulevard, St. Louis, Missouri, 63167.
⁷Carolina Calcium Products Division, Highway 176 East, Campobello, South Carolina, 29322; TEL: 803-468-4588
⁸Any suitable starch such as, but not limited to, Argo Corn Starch.
⁹Any suitable resin will suffice such as, but not limited to, melamine resin, benzoguanamine resin, glycoluril resin or urea resins.

TABLE 3

| | | Approximate | |
|---|---|---|---|
| | | Amounts | |
| | Composition | in Ounces | Amounts by weight per 100 parts of |
| # | Ingredients | weight | acrylic co-polymer |
| 1 | Acrylic co- | 10 oz | 100 parts by weight |
| | polymer | | |
| | (e.g., | | |
| | VF-812) | | |
| 2 | Magnesium | 6 oz to 10 oz | About 60 to about 100 parts by weight |
| | Sulfate | | per 100 parts of acrylic co-polymer |
| 3 | Tricalcium | 6 oz to 8 oz | About 60 to about 80 parts by weight |
| | phosphate | | per 100 parts of acrylic co-polymer |
| 4 | Resin¹ | 1 oz to 2 oz | About 10 to about 20 parts by weight |
| | | | per 100 parts of acrylic co-polymer |
| 5 | Borax | 4 oz to 8 oz | About 40 to about 80 parts by weight |
| | | | per 100 parts of acrylic co-polymer |
| 6 | Ammonium | 1 oz to 2 oz | About 10 to about 20 parts by weight |
| | chloride | | per 100 parts of acrylic co-polymer |
| 7 | Calcium | 2 oz to 4 oz | About 20 to about 40 parts by weight |
| | carbonate | | per 100 parts of acrylic co-polymer |
| 8 | Aluminum | 1 oz to 2 oz | About 10 to about 20 parts by weight |
| | Potassium | | per 100 parts of acrylic co-polymer |
| | Sulfate | | |
| 9 | Alumina | 2 oz to 4 oz | About 20 to about 40 parts by weight |
| | Trihydrate | | per 100 parts of acrylic co-polymer |
| 10 | Perlite | 4 oz to 8 oz | About 40 to about 80 parts by weight |
| | | | per 100 parts of acrylic co-polymer |
| 11 | Vermiculite | 2 oz to 8 oz | About 20 to about 80 parts by weight |
| | | | per 100 parts of acrylic co-polymer |
| 12 | Corn Starch | 2 oz to 4 oz | About 20 to about 40 parts by weight |
| | | | per 100 parts of acrylic co-polymer |

¹Any suitable resin will suffice such as, but not limited to, melamine resin, benzoguanamine resin, glycoluril resin or urea resins.

I claim:

1. A fire retardant composition able to withstand 5,000° F., comprising:
an acrylic copolymer;
about 60 to about 100 parts of magnesium sulfate per 100 parts of acrylic copolymer by weight;
about 60 to about 80 parts of tricalcium phosphate per 100 parts of acrylic copolymer by weight;
about 10 to about 20 parts of resin per 100 parts of acrylic copolymer by weight;
about 40 to about 80 parts of borax per 100 parts of acrylic copolymer by weight;
about 10 to about 20 parts of ammonium chloride per 100 parts of acrylic copolymer by weight;
about 20 to about 40 parts of calcium carbonate per 100 parts of acrylic copolymer by weight;
about 10 to about 20 parts of aluminum potassium sulfate per 100 parts of acrylic copolymer by weight;
about 20 to about 40 parts of alumina trihydrate per 100 parts of acrylic copolymer by weight;
about 40 to about 80 parts of perlite per 100 parts of acrylic copolymer by weight;
about 20 to about 80 parts of vermiculite per 100 parts of acrylic copolymer by weight; and
about 1 to about 40 parts of corn starch per 100 parts of acrylic copolymer by weight.

2. The fire retardant composition according to claim 1, wherein the amount of corn starch is about 20 to 40 parts per 100 parts of acrylic copolymer by weight.

3. The fire retardant composition according to claim 1, wherein the acrylic copolymer is VF-812.

4. The fire retardant composition according to claim 1, wherein the acrylic copolymer is styrene-acrylic copolymer.

5. The fire retardant composition according to claim 1, wherein the resin is melamine resin.

6. The fire retardant composition according to claim 1, wherein the resin is at least one resin selected from the group consisting of: melamine resin, benzoguanamine resin, glycoluril resin and urea resin.
